(19) United States
(12) Patent Application Publication
(10) Pub. No.: US 2003/0212180 A1
(43) Pub. Date: Nov. 13, 2003

(54) Method of manufacturing a compound based on a thermoplastic

(75) Inventors: Andreas Rietz, Nuernberg (DE); Friedrich Muller, Lauf (DE); Susanne Brix, Eckenthal (DE)

Correspondence Address: SUGHRUE MION, PLLC, 2100 Pennsylvania Avenue, NW, Washington, DC, 20037-3213, US

(73) Assignee: NEXANS

(21) Appl. No.: 10/369,557

(22) Filed: Feb. 21, 2003

(30) Foreign Application Priority Data
Feb. 22, 2002 (DE) 10207673.1

(51) Int. Cl. C08K 3/10; C08G 2/00

(52) U.S. Cl. 524/436; 522/6; 524/437

(57) ABSTRACT

A method of manufacturing a compound based on a thermoplastic, which may be cross-linked through irradiation using light lying in the ultraviolet range, is indicated. In this case, at least one photoinitiator and one cross-linking agent are added to a thermoplastic base material. To manufacture the compound, 0.2 to 3 parts of an alkyl benzophenone and/or a derivative thereof as a photoinitiator and 0.2 to 3 parts of a cross-linking agent and 0.1 to 5 parts stabilizers are added to 100 parts base material.

### BACKGROUND OF THE INVENTION

This application is based on and claims the benefit of German Patent Application No. 10207673.1 filed Feb. 13, 2002, which is incorporated by reference herein.

The present invention relates to a method of manufacturing a compound based on a thermoplastic, which may be cross-linked through irradiation using light lying in the ultraviolet range, in which at least one photoinitiator and one cross-linking agent are added to a thermoplastic base material (European Patent Application 0 490 854 B1).

Thermoplastics are not usable for many technical applications without special treatment, since, for example, they become soft and even melt at higher temperatures. Through cross-linking, the properties of thermoplastics may be changed in such a way that they may be used for nearly all technical applications. Thus, for example, the tensile strength, abrasion resistance, and dimensional stability of many materials may be increased through cross-linking. The materials also obtain greater resistance to oil, solvents, and other aggressive media.

Chemical methods, in which, for example, peroxide is added to the base material, are known for cross-linking thermoplastics, for example (U.S. Pat. No. 3,392,135 A). The cross-linking is performed under the application of high temperatures and pressures, which requires a significant amount of energy and a large outlay for equipment. These drawbacks of chemical cross-linking do not exist in physical cross-linking using electron beams (German Patent 34 24 128 C2). Rather, a rapid and continuous mode of operation is allowed which may be used in practice for many thermoplastics and even elastomers. However, facilities for irradiation cross-linking are expensive. In addition, they require measures to avoid leakage radiation and for effective protection of operating personnel.

A method of continuous cross-linking of ethylene plastics containing a photoinitiator, in which ultraviolet light is used for the cross-linking, is described in European Patent Application 0 490 854 B1, cited at the beginning. A benzophenone derivative having a high molecular weight is used as a photoinitiator. This method is restricted to ethylene plastics, particularly polyethylene, and the special photoinitiator.

### SUMMARY OF THE INVENTION

The present invention is based on the object of designing the method initially described in such a way that it may be used for any desired thermoplastic materials.

This object is achieved according to the present invention in that 0.2 to 3 parts of an alkyl benzophenone and/or a derivative thereof as a photoinitiator and 0.2 to 3 parts of a cross-linking agent and 0.1 to 5 parts stabilizers are added to 100 parts base material.

The alkyl benzophenone used as a photoinitiator in this method is a commercially available material, as are its derivatives, which are also usable. Surprisingly, it has been shown that by adding these materials to different thermoplastics, it is possible to cross-link the thermoplastics through ultraviolet light. In this case, no chemical reaction processes are necessary, but rather the addition of alkyl benzophenone or a derivative thereof to the respective base material, in an amount which may be predetermined, suffices. Only the respective intended purpose determines which thermoplastic is to be used. Usable thermoplastics are particularly polyvinyl chloride, polypropylene and its copolymers, polyethylene and its copolymers, polyurethane, and ethylene vinyl acetate. The alkyl benzophenone “dodecyl benzophenone” is particularly suitable as a photoinitiator in this regard.

The method is particularly advantageous in the manufacture of electric lines, in which the compound may be used as an insulating material for conductors or even as a sheathing material. It is then possible to cross-link the compound in continuous passage at typical take-up speeds. In this case, the wall thicknesses of the layers to be cross-linked and the output of the UV lamp(s) used are appropriately tailored to one another.

The method is also usable for compounds which must meet increased requirements for non-combustibility, flame resistance, and smoke production. For this purpose, flame retardants and fireproofing agents as well as further fillers, such as chalk, may be added to the compound.

### DETAILED DESCRIPTION OF THE INVENTION

The method according to the present invention and its application for electric lines is described in the following in exemplary embodiments.

The following materials may be used as thermoplastics which may be cross-linked using ultraviolet (UV) light, for example:

Polyvinyl chloride, polypropylene and copolymers thereof, polyethylene and copolymers thereof, polyurethane, and ethylene vinyl acetate. This only indicates a selection of thermoplastics which may be used in principle. In the following, polyurethane is considered as representative of all other usable materials.

A compound which may be cross-linked by UV light and may be manufactured using the method according to the present invention has the following composition, for example:

100 parts polyvinyl chloride

0.2 to 3 parts alkyl benzophenone

0.2 to 3 parts cross-linking agent

0.1 to 5 parts stabilizers.

Dodecyl benzophenone is advantageously used as the alkyl benzophenone. Suitable cross-linking agents are primarily trimethylol propane trimethacrylate (TRIM) or triallyl cyanurate (TAC). The stabilizers also include antioxidants and aging protective agents.

The fire behavior of the compound may be improved by adding suitable materials. Such materials to be added to the compound described above are, for example:

10 to 120 parts chalk as a filler

20 to 160 parts of a flame retardant

2 to 50 parts of a flame protection agent.

Aluminum trihydroxide (ATH) and magnesium hydroxide (Mg(OH)₂) are particularly suitable as flame retardants. Decabromodiphenyloxide or dodecachlorododecahydro-dimethanodibenzo-cyclooctene may be used as fireproofing agents, for example, each in combination with antimony trioxide. Besides antioxidants and aging protective agents, lubricants and plasticizers may additionally be added.

The compound manufactured using the method according to the present invention may advantageously be used in the manufacture of electric lines. The compound is then used as an insulating material, specifically as insulation for electric lines or as sheathing for lines in whose core at least two insulated lines are combined. For this purpose, the compound is fed to an extruder which shapes the respective insulating layer in continuous passage around a line or core. In the same work cycle, the compound is also cross-linked in continuous passage using UV light.

If, for example, an electric line is to be insulated, an insulation having a wall thickness between 0.1 mm and 0.8 mm is produced. The insulation is preferably between 0.2 mm and 0.5 mm thick. The insulated line is irradiated using UV light to cross-link the insulation. For this purpose, at least one UV lamp (radiator) having an output between 50 watts/cm and 300 watts/cm is used. Expediently, two or more UV lamps are positioned offset around the circumference of the insulated line. At higher take-up speeds, additional UV lamps may also be positioned offset in the take-up direction. The output of the respective UV lamps to be used depends on the actual thickness of the insulation, which lies within the limits indicated.

If the compound is to be used as sheathing for an electrical line, then the wall thickness to be extruded may be between 0.2 mm and 1.2 mm, for example. The same applies analogously for cross-linking the respective sheathing as was described above for the insulation of a line.

What is claimed is:

1. A method of manufacturing a compound based on a thermoplastic, which may be cross-linked through irradiation using light lying in the ultraviolet range, in which at least one photoinitiator and one cross-linking agent are added to a thermoplastic base material,
characterized in that 0.2 to 3 parts of an alkyl benzophenone and/or a derivative thereof as a photoinitiator and 0.2 to 3 parts of a cross-linking agent and 0.1 to 5 parts stabilizers are added to 100 parts base material.

2. The method according to claim 1,
characterized in that dodecyl benzophenone is used as a photoinitiator.

3. The method according to claim 1,
characterized in that trimethylol propane trimethacrylate is used as a cross-linking agent.

4. The method according to claim 1,
characterized in that triallyl cyanurate is used as a cross-linking agent.

5. The method according to claim 1,
characterized in that additional materials for improving fire behavior are added to the base material.

6. The method according to claim 5,
characterized in that 10 to 120 parts chalk, 20 to 160 parts flame retardant, and 2 to 50 parts fireproofing agents are added to the compound.

7. The method according to claim 6,
characterized in that aluminum trihydroxide is used as a flame retardant.

8. The method according to claim 6,
characterized in that magnesium hydroxide is used as a flame retardant.

9. A method of manufacturing an electric line having a core containing at least one electric conductor using the compound according to claim 1,
using which a layer made of the compound is extruded around the core and the insulating material is then cross-linked through irradiation with light lying in the ultraviolet range.

10. The method according to claim 9,
characterized in that
the layer made of insulating material is applied to the core using a wall thickness between 0.1 mm and 1.2 mm and
at least one lamp which emits ultraviolet light, having an output between 50 watts/cm and 300 watts/cm, is used for cross-linking the insulating material.

11. The method according to claim 10,
characterized in that a layer made of insulating material having a wall thickness between 0.2 mm and 0.5 mm is extruded.

12. The method according to claim 10,
characterized in that two or more lamps are used for irradiating the insulating material.
